(19) United States
(12) Patent Application Publication
(10) Pub. No.: US 2006/0082564 A1
(43) Pub. Date: Apr. 20, 2006

(54) Display apparatus

(75) Inventors: Ran Poliankine, Motza Ilit (IL); Roy Segev, Mevasseret Zion (IL)

Correspondence Address: FOLEY AND LARDNER LLP;SUITE 500, 3000 K STREET NW, WASHINGTON, DC, 20007, US

(73) Assignee: MAGINK DISPLAY TECHNOLOGIES LTD.

(21) Appl. No.: 11/248,003

(22) Filed: Oct. 12, 2005

(30) Foreign Application Priority Data
Oct. 14, 2004 (GB) 0422876.3

(51) Int. Cl. G09G 5/00

(52) U.S. Cl. 345/204

(57) ABSTRACT

A display apparatus 1 comprises a reflective display device 10 which is electrically switchable between stable states in which the display device 10 displays a different image without consuming power. The display apparatus 1 has a control circuit 40 arranged to switch the display device 10 cyclically between the stable states. The display apparatus 1 can be used as label, the cyclical change between the different images attracting attention to the display apparatus 1. To minimise the size of the display apparatus 1, the control circuit 40 is formed on a circuit board 4 fixed to the rear of the display device 10 and consists of printed circuit components. An attachment means 8 fixed to the rear of the display device 10 allows attachment to another item. Operation may occur in response to sensing by a sensor 44 of an external stimulus such as a signal. The display device 10 may comprise a bistable reflective layer such as a cholesteric liquid crystal layer 18.

### FIELD OF THE INVENTION

The present invention relates to a display apparatus which may be used to visually attract attention to an item which might otherwise not be readily seen.

### DESCRIPTION OF RELATED ART

There are many circumstances in which a person needs to locate or notice an individual item against its surroundings. This may be difficult where the surroundings contain a large number of similar items or hide the item. Examples are where books, documents or data storage mediums are stored with other similar items, where items are being sold in a shop, or in gatherings where people are identified by badges. This is usually done by a label bearing printed or written characters or images. Such labels have the advantage of being cheap to produce, the cost being of high importance in the types of situation concerned because of the large number of items typically labelled. However, with such a label it can remain hard to locate or notice an individual item against its surroundings typically because there are many similar items and labels. The present invention is concerned with providing an improved way to locate or identify individual items in this type of situation.

### BRIEF SUMMARY OF THE INVENTION

The present invention provides a display apparatus which attracts visual attention, for example to be attached to such an item to draw attention to it, inter alia, to assist a person seeking out the item. In particular the display apparatus is configured to minimise the cost whilst at the same time whilst at the same time attracting visual attention.

According to the present invention, there is provided a display apparatus comprising a reflective display device which comprises:
at least one bistable reflective layer which is electrically switchable between a first and a second stable states in which the bistable reflective layer consumes no power, the at least one bistable reflective layer reflecting light in the first stable state and transmitting or absorbing light in the second stable state; and
transparent electrodes shaped to apply electric fields across to N areas of the at least one bistable reflective layer, where N is an integer of at most 100, for electrically switching the N areas of the at least one bistable reflective layer between the first and second stable states,
the display apparatus further comprising a control circuit electrically connected to the transparent electrodes, the control circuit being operative to generate and supply to the transparent electrodes drive pulses which respectively switch the N areas between the first and second stable states to cause the reflective display device to display said different images successively in a cycle.

The fundamental technology of the display device and its manner of operation employing a bistable reflective layer, transparent electrodes and a control circuit to drive switching of the bistable reflective layer between its stable states is known in general terms in a number of existing display devices, for example display devices using cholesteric liquid crystal material. However, the present invention adapts such known display devices to produce a low cost device which may be used to attract attention visually.

In particular, known display devices employing a bistable reflective layer, transparent electrodes and a control circuit have generally been developed with a large number of pixels, that is areas of the bistable reflective layer which are arranged in a two-dimensional array and selectively addressable in parallel in accordance with image data to allow the display of different images. Typically the number of pixels is many hundreds or even thousands, for example with resolutions of from 320 pixels by 200 pixels to 640 pixels by 480 pixels to meet the Video Graphics Adapter (VGA) standard. In contrast, the present invention reduces the number N of areas of the bistable reflective layer driven by the transparent electrodes to be at most 100 and at the same time the control circuit is operative to cause the display device to display different images in a cycle.

The change in the image displayed on the display device visually draws attention of a person to the display apparatus. This is a much more effective way of attracting attention than a simple label which bears a static image because the eye of the viewer is drawn to the change in the image. Thus the device is very effective. As the primary purpose of the device is to so attract attention, the number of areas driven by the transparent electrodes can be reduced as compared to known display devices having a large two-dimensional array of pixels. This produces a significant reduction in cost as compared to such display devices having a large two-dimensional array of pixels where it is usually desired to increase the number and reduce the size of the individual areas to increase resolution for a given size of display.

In the simplest forms of the display device, there are a smaller number N of areas, perhaps just one or two. In this case switching of the area between the two stable states causes the display of different images having the same form but different colours, thereby creating the perception that the image appears to flash. Other more complicated changes are possible, for example introducing a degree of motion into the perceived image. Thus it will be appreciated that the present invention does not require the use of an array of separately addressable pixels (although small arrays are possible in more complicated types of embodiment).

This makes the display apparatus useful for many applications. For example, the display apparatus may be attached to an item to draw attention to that item. This may allow the item to be identified from amongst a large number of similar items such as in a filing system of books, documents or data storage media. Alternatively, it may allow the item to be noticed in other situations, for example if the item is for sale in a shop. Another possibility is that the display apparatus may be used in a badge to identify individuals, for example in a gathering. Other uses taking advantage of the visual attraction of attention will equally be apparent.

Particular advantage is derived from the use of a display device having stable states in which an image is displayed without consuming power. This of course reduces power consumption which in turn minimises the size and cost of the battery arrangement powering the display apparatus. Low cost is of advantage in the intended use to attract attention to items of which there will typically be many. Minimisation of the size of the display apparatus is also particularly advantageous where the display apparatus is to be used to attract attention, because this will typically be in situations where a bulky display apparatus would be inconvenient.

Advantageously, the control circuit is formed at the rear of the display device, for example on a circuit board fixed to the rear of the display device. This arrangement is convenient, reduces the footprint of the apparatus on an item to which it might be attached, and in use allows the control circuit to be hidden by the display device.

Advantageously, the control circuit consists of printed circuit elements. The use of printed circuit elements without the thickness of the control circuit to be minimised. This reduces the size of the display apparatus which is advantageous as described above.

The display apparatus may further comprise attachment means, fixed to the rear of the display apparatus, for attaching the display apparatus to another item. In this way, the display apparatus is adapted for attachment to an item to which it is desired to draw attention. Of course it is alternatively possible to provide the display apparatus without such attachment means in which case a user can provide the attachment at a later time.

Advantageously, the control circuit further comprises a sensor capable of sensing an external stimulus and the control circuit is operative in response to the sensor sensing said external stimulus. This allows control of the operation of the display apparatus. For example, the sensor may be a receiver for receiving a signal as said external stimulus. In this case, the signal may be used to cause the display device to commence the cyclical display of the different images. This is particularly useful where several display apparatuses are used to identify different items stored together. By transmitting the signal of an appropriate display apparatus, it is possible to cause selective operation of the corresponding display apparatus which allows an individual item to be identified.

Desirably, the display apparatus comprises a single bistable reflective layer. This reduces the cost of the display apparatus as compared to the use of plural bistable reflective layers. Nonetheless, the use of a single bistable reflective layer still allows the switching between two stable states allowing two different images alternately to be displayed, thereby meeting the primary function of the display apparatus of visually attracting attention.

Alternatively, it is possible to employ more than one bistable reflective layer which allow the selective display of a larger number of different colours, but this causes a corresponding increase in the cost of the apparatus.

The display device may employ a number of different display technologies which allow electrical switching between at least two stable states, but is preferably a cholesteric device in which the bistable reflective layer(s) is a cholesteric liquid crystal layer.

To allow better understanding, an embodiment of the present invention will now be described by way of non-limitative example with reference to the accompanying drawings.

### BRIEF DESCRIPTION OF THE DRAWINGS

In the drawings:

FIG. 1 is a respective view of a display apparatus;

FIG. 2 is a cross-sectional view of the display device of the display apparatus of FIG. 1 taken across the layered structure of the display device;

FIG. 3 is a plan view of the components of the display apparatus with the display advice and the control circuit shown unfolded.

FIG. 4 is a circuit diagram of the control circuit of the display apparatus; and

FIG. 5 is a table illustrating various effects which can be produced in stable states of the display device.

### DETAILED DESCRIPTION OF THE INVENTION

There will now be described a display apparatus 1 which embodies the present invention.

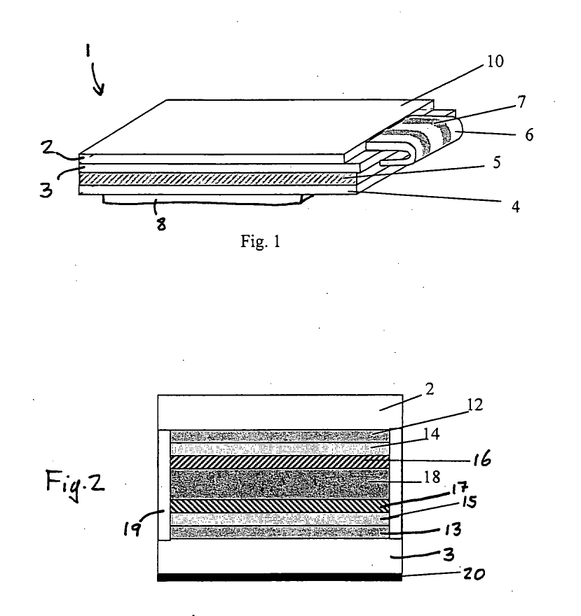

As shown in FIG. 1, the display apparatus 1 has two main parts, the first part being a display device 10 incorporating two substrates 2 and 3, and the second part being a circuit board 4 on which is formed a control circuit 40 as described in more detail below. The circuit board 4 is fixed to the rear of the display device 10 by a layer of adhesive 5, although any alternative means for fixing could be used. Thus the circuit board 4 is hidden behind the display device 10.

As an alternative to the use of a separate circuit board 4, the control circuit could be formed directly on the display device on either one of the substrates 2 or 3 using known chip-on-glass (COG) techniques.

Arranged between the display device 10 and the circuit board 4 is a flexible connector 6 formed on a polymer substrate on which is formed conductive tracks 7 which electrically connects the control circuit 40 formed on the circuit board 4 to the display device 10. The connector 6 and conductive tracks 7 may be formed as a flexible printed circuit (FPC). As an alternative, the connector 6 and conductive tracks 7 can be replaced by other means providing the electrical connection, such as conductive resins, eg conductive epoxy resins, or metals deposited by evaporation techniques.

Fixed to the rear of the circuit board 4 is an adhesive layer 8 which may be used as a means for attaching the display apparatus 1 to another item. The adhesive layer may be a pressure sensitive adhesive and may optionally be protected by a removal protective film (not shown). As an alternative to the adhesive layer 8, the display apparatus 1 may be provided with other attachment means for attaching the display apparatus 10, for example a mechanical fixing such as a clip or pin. In general the adhesive layer 8 or other attachment means may either allow the display apparatus 1 to be fixed once only or may allow re-use.

The display device 10 will now be described.

The display device 10 is a reflective display device which does not employ any back-light, thereby reducing power consumption. Furthermore, the display device 10 is a bistable device which is electrically switchable between at least two stable states. In each state, the display device 10 displays a different image, these images being displayed without the display device 10 consuming any electrical power. Therefore, the power consumption of the display device 10 is low because power is only consumed to electrically switch the display state, but not to maintain it. The display device 10 may be of a number of different types. Preferably, the display device 10 is of a type that gives a bright visual effect. Some possible types for the the display device 10 are, but not exclusively:
a surface or bulk-stabilised cholesteric device
a bistable nematic devices (such as sold under the trade mark BiNem by the company Nemoptic or such as sold by the company ZBD Displays Limited)
an electrochromic device (such as sold by the company Ntera Limited)
an electrophoretic device (such as sold by the company E-Ink Corporation)

The preferred form of the display device 10 is as a cholesteric device. An example of the display device 10 will now be described.

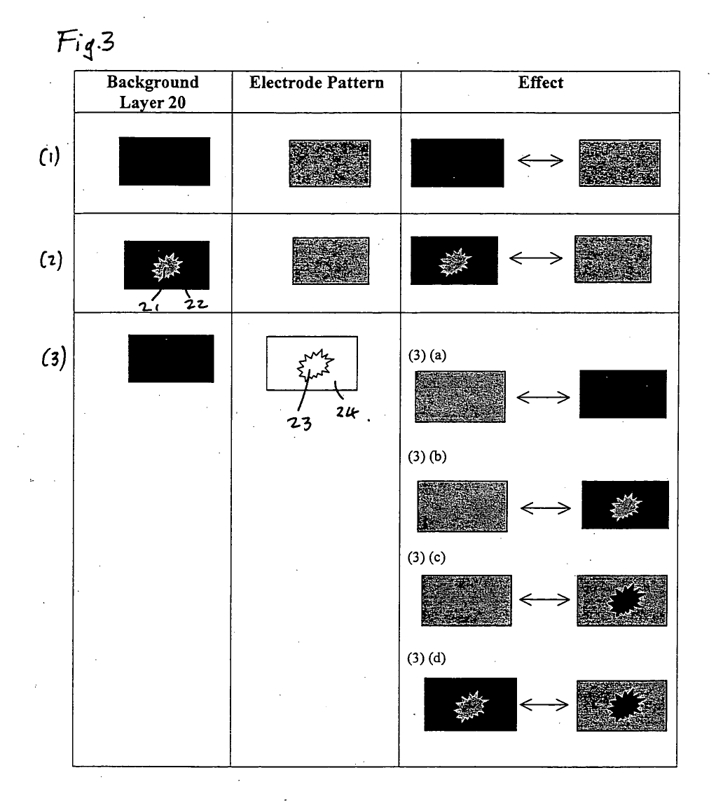

The display device 10 has a layered construction as shown in FIG. 2 in which the thickness of the individual layers is exaggerated for clarity.

The display device 10 comprises two rigid substrates 2 and 3, which may be made of glass or preferably plastic. The substrates 2 and 3 have, on their inner facing surfaces, respective transparent electrodes 12 and 13 formed as a layer of conductive material, typically indium tin oxide. The electrodes 12 and 13 are shaped as described below. Optionally, the electrodes 12 and 13 are overcoated with a respective insulation layer 14 and 15, for example of silicon dioxide.

The two substrates 2 and 3 define a cell, typically having a thickness of 3 μm to 10 μm, containing a liquid cystal layer 18 of cholesteric liquid crystal material contained by a glue seal 19 around the perimeter of the display device 10. Thus the liquid crystal layer 18 is arranged between the electrodes 12 and 13.

Each substrate 2 and 3 is further provided with a respective alignment layer 16 and 17 formed adjacent the liquid crystal layer 18 on the outside of the electrode 12 or 13, or the insulation layer 14 or 15 if provided. The alignment layers 16 and 17 align and stabilise the liquid cystal layer 18 and are typically made of polyamide which may optionally be unidirectionally rubbed. Thus, the liquid crystal layer 19 is surface-stabilised, although it could alternatively be bulk-stabilised.

On the rear surface of the rear substrate 3 (lowermost in FIG. 2), the display device has a coloured background layer 20 typically formed as a film of paint.

The layered structure of the display device 10 as described above is known in itself and may be manufactured using conventional techniques.

The operation of the display device 10 is as follows.

The cholesteric liquid crystal in the liquid crystal layer 18 has two stable states which can coexist when no voltage is applied to the liquid crystal layer 18. These stable states are the planar and focal conic states, as described in I. Sage, Liquid Crystals Applications and Uses, Editor B Bahadur, vol 3, page 301, 1992, World Scientific, which is incorporated herein by reference and the teachings of which may be applied to the present invention. The planar state and the focal conic state are used in the present embodiment because they are stable states in the sense that they remain and can coexist in the absence of any applied drive signal. Cholesteric liquid crystal material also has a homeotropic (pseudo nematic) state but this state is not used in the present embodiment because it is unstable in the sense that maintenance of the homeotropic state requires continuous application of a drive signal.

In the planar state (first state), the liquid crystal layer 18 selectively reflects a bandwidth of light that is incident upon it. The wavelength λ of the reflected light is given by Bragg's law, ie λ=nP, where wavelength λ of the reflected wavelength, n is the mean refractive index of the liquid crystal and P is the pitch length of the cholesteric liquid crystal. Thus any colour can be reflected as a design choice by selection of the pitch length P.

The rest of the light not reflected by the liquid crystal layer 20 is transmitted and absorbed by the background layer 20. The colour of the background layer 20 can modify the colour of the reflected light. If the colour of the background layer 20 is black, then only the light reflected from the liquid crystal layer 18 is seen. On the other hand, if the background layer 20 has a colour other than black, the light reflected from the background layer 20 is mixed with the light reflected from the liquid crystal layer 18 and a combined colour is seen. In other words, the colour seen on the display device 10 in this state is controlled by selection of the colour of the light reflected by the liquid crystal layer 18 in combination with the colour of the background layer 20.

In the focal conic state, the liquid crystal layer 18 is, relative to the planar state, transmissive and transmits substantially all the incident light. Strictly speaking, the liquid crystal layer 18 is mildly light scattering with a small reflectance, typically of the order of 3-4%. Thus, in this state the colour seen on the display device 10 is the colour of the background layer 20.

The control circuit 40 which is described in more detail below supplies drive pulses to the transparent electrodes 12 and 13 to apply an electric field across the liquid crystal layer 18 and thereby effect switching between the two states. This effect is described in W. Gruebel, U. Wolff and H. Kreuger, Molecular Crystals Liquid Crystals, 24, 103, 1973, which is incorporated herein by reference and the teachings of which may be applied to the present invention. The drive pulses are only supplied when the liquid crystal layer 18 is required to change from the planar state to the focal conic state and vise versa. Typically the drive pulses are of 30V to 60V in the form of an AC pulse of duration 50-100 ms to switch the liquid crystal into the planar state and are one or more (often 2 to 5) pulses of 10V to 20V and 50 ms duration to switch the liquid crystal into the focal conic state. The optimisation of the drive pulses may be found experimentally for a given configuration of the display device 10 as the exact amplitude and duration depends on a number of factors such as the thickness of the liquid crystal layer 18, the dielectric anisotropy of the liquid crystal and temperature. Thus the actual drive pulses may differ from the values given above but those values are suitable starting values for the optimisation process.

The transparent electrodes 12 and 13 are shaped to apply electric fields across N areas of the liquid crystal layer N, where N is at most 100, preferably at most 25, more preferably at most 16 and most preferably 1 or 2. Such small numbers N of areas driven by the electrodes 12 and 13 reduces the cost of the diaply device as compared to more display devices having electrode with more pixels.

The transparent electrodes 12 and 13 may be shaped in a predetermined pattern so that the N areas driven by the electrodes 12 and 13 are shaped in the same predetermined pattern. Additionally, or alternatively, the background layer 20 may have a predetermined pattern. The predetermined patterns of the N areas driven by the electrodes 12 and 13 and/or the background layer, together with the colour of the light reflected from the liquid crystal layer 18 and the colour of the background layer 20, so that the display device 10 displays different images on switching of the stable states of the liquid crystal layer 18. There are many options for the nature of the images. Some of these options will now be described with reference to FIG. 3. FIG. 3 shows for each option: in the first column the nature of the background layer 20; in the second column the predetermined pattern of the electrodes 12 and 13 and hence the N areas; and in the third column the effect on switching between the two states. In FIG. 3, the dark shading and light shading illustrate two different colours, either of which may be lighter in reality.

Differences in colour between the two states may be achieved by selection of the colour of the light reflected from the liquid crystal layer 18 and the colour of the background layer 20, as described above. Some examples of possible colour combinations are shown in the following table, although this is by no means limitative.

| colour of the light | colour of the | | |
|---|---|---|---|
| reflected from the | background | colour seen in | colour seen in |
| liquid crystal layer 18 | layer 20 | planar state | focal conic state |
| green | black | green | black |
| green | red | yellow | red |
| yellow | blue | white | blue |
| red | yellow | orange | yellow |
| blue | red | magenta | red |

The background layer 20 may be a uniform colour or may be patterned to create the image.

Therefore, in the simplest forms of the display device 10, N is 1 and the electrodes 12 and 13 are arranged each as a single element over an area of the display device 10 which is therefore addressable in common. The electrodes 12 and 13 may be arranged over the entire area of the display device 10 or may have a pattern such as a character or a picture. In such forms of the display device 10, switching of the area of the liquid crystal layer 18 causes the colours to change, for example between the colours of the two states set out in the table above, and therefore the device 10 displays images of different colours which the viewer perceives as an image which flashes.

Option (1) of FIG. 3 illustrates such a form of display device 10 in which the background layer 20 is a uniform colour and the electrodes 12 and 13 are arranged over a single area which is the entire area of the display device 10. In this case, the entire display device 10 appears to change colour between the two states.

Option (2) of FIG. 3 illustrates such a form of display device 10 in which the electrodes 12 and 13 are arranged over the entire area of the display device 10 and the background layer 20 has a predetermined pattern with a portion 21 of the background layer 20 having a colour matching the colour of light reflected by the liquid crystal layer in the planar state and the remainder 22 of the background layer 20 is of a contrasting colour. In this case, the said portion 21 of the background layer 20 appears to be the same colour in both states and the said remainder 22 of the background layer 20 appears to change colour between the two states.

In more complex forms of the display device 10, N>1 and so the electrodes 12 and 13 are arranged over plural areas of the display device 10 which are addressable separately. In this case, one of the electrodes 12 and 13 is divided into separate, isolated areas. The other of the electrodes 12 and 13 may either be separated into separate, isolated areas of the same shape, or may be shaped as a common electrode extending across plural areas. Thus respective drive pulses supplied to the respective areas of the electrodes 12 and 13 apply an electric field across the adjacent areas of the liquid crystal layer 18. In such forms of the display device 10, switching of the areas of the liquid crystal layer 18 causes the colours of the different areas to change, for example between the colours of the two states set out in the table above. This may be used to cause the device 10 to display images of different colours which the viewer perceives as an image which flashes, or may be used to cause the device 10 to display images which the viewer perceives as a motion image.

Option (3) of FIG. 3 illustrates such a form of display device 10 in which N=2 and the electrodes 12 and 13 are arranged over two areas 23 and 24 of the display device 10 which are addressable independently. The change in the image between different pairs of states is shown. Option (3)(a) shows the states in which the two areas 23 and 24 are switched together. In this case, the entire display device 10 appears to change colour between the two states, as in option (1) above. Option (3)(b) shows the states in which only the area 24 is switched, so the area 24 appears to change colour between the two states. Option (3)(c) shows the states in which only the area 23 is switched, so the area 23 appears to change colour between the two states. Option (3)(d) shows the states in which the two areas 23 and 24 are switched in opposition. In this case, both areas 23 and 24 appear to change colour in opposition between the two states. Thus in each of options (3)(b) to (3)(d), the pattern of the two areas is visible and appears to change colour between the two states.

In yet more complicated arrangements, the electrodes 12 and 13 may be arranged to provide a rectangular array of areas of the display device 10 which are addressable independently as separate pixels in the manner of a conventional display device. However this is not essential and in the context of the present invention provides the disadvantage of increasing the number of electrical connections between the display device 10 and the control circuit 40 and of increasing the cost

As described above, the display device 10 has a single liquid crystal layer 18. As an alternative, the display device 10 could employ plural liquid crystal layers each controllable independently. This would provide the display device 10 with a larger number of states with a larger number of colours available. However, the increased number of liquid crystal layers would increase the cost and are not necessary for the basic function of the display device.

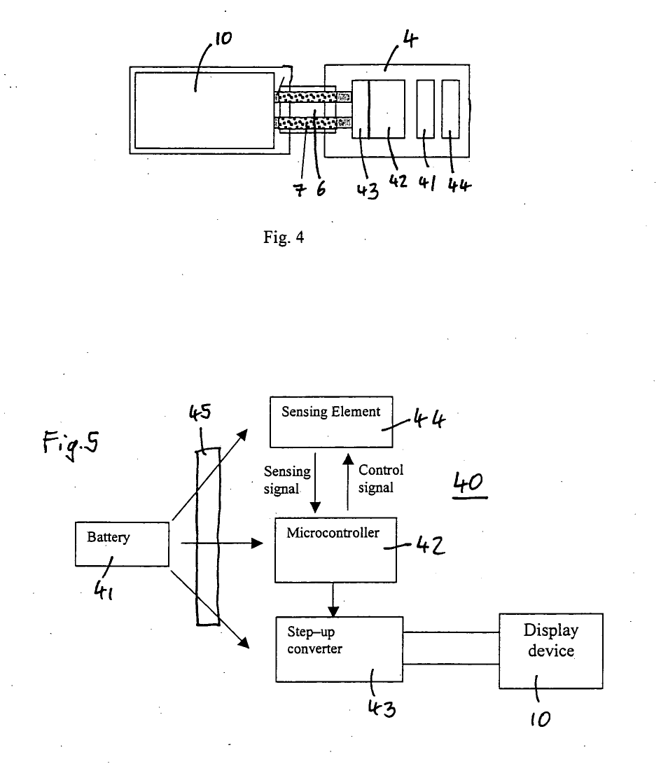

The control circuit 40 will now be described with reference to FIG. 4 which shows the layout of the control circuit 40 on the circuit board 4 and to FIG. 5 which is a circuit diagram of the control circuit 40.

The control circuit 40 consists of printed circuit components using known printed thin film technology. This advantageously minimises the thickness of the display apparatus 10. However as an alternative, any of the elements of the control circuit 40 could be conventional electronic components.

The control circuit 40 is powered by a battery arrangement 41 which supplies power to the other elements of the control circuit 40 which include a microcontroller 42, a step-up converter 43 and a sensor 44. The battery arrangement 41 may be a low cost, small, flat battery such as a Zn-manganese dioxide battery supplied by the company Power Paper delivers 1.5V or a Li-manganese dioxide battery supplied by the company Varta (LFP-25 having dimensions of 22×29×0.4 mm or LFP-7 having dimensions of 9×29×0.4 mm) that delivers 3V. Advantageously, the battery arrangement 41 delivers 3V to reduce the cost of the microcontroller 42, but of course if an individual battery delivers 1.5V it is straightforward to use two batteries in series.

The step-up converter 43 is connected to the display device 10, in particular to the electrodes 12 and 13 through the connector 6. To generate drive pulses, the step-up converter, under the control of the microcontroller 42, converts the DC voltage from the battery arrangement 41 into the appropriate driving pulses for switching the state of the liquid crystal layer 18. The step-up converter 43 may take a wide range of forms for example being a MAX5028, MAX1522, MAX1523 etc supplied by the company Maxim Integrated Products or being, at lower cost, a simple self-inductance transformer.

The microcontroller 42 works off the battery voltage and may take a wide range of forms for example being a PIC 12C508 supplied by the company Microchip Technology Inc. or a EM 6607 supplied by the company EM Microelectronic. The microcontroller 42 controls the step-up converter 43 and the sensor 44 so they only consume power when activated by the microcontroller via a control signal.

The sensor 44 is responsive to an external stimulus. The sensor 44 may be a receiver for receiving a signal from an external transmitter (not shown) as the external stimulus, using any of a wide range of signal transmission technologies, for example IRFD, RF, IR etc. This allows the display apparatus 1 to be selectively activated. Alternatively, the sensor 44 may sense some other external stimulus, for example the proximity of an object.

Optionally, the control circuit 40 may also include a switch 45 to allow a user to turn the display apparatus 1 on and off. The switch 45 may be a simple breakable area of the device can be snapped or bent to provide an electrical contact or may be a more complicated component. The switch 45 prevents operation of the display apparatus 1 before it reaches the end user which is advantageous to conserve the finite life of the battery arrangement 41.

In operation, the microcontroller 42 works mainly in stand by mode during which time the power consumption is less than 1 μA. Peridocially, for example every second or so, the microcontroller 42 activates the sensor 44, say for about 2 ms to listen to the host. This listening stage will consume for example 20 μA but the duty cycle is only 1/500 so average current is 0.04 μA.

When the sensor 44 senses the external stimulus, it sends a sensing signal to the microcontroller 42.

In the absence of the sensing signal, the microcontroller 42 prevents operation of the step-up converter 43 so that no drive pulses are sent to the display device 10 and thus the image seen is static.

In response to a sensing signal from the sensor 44, the microcontroller 42 control the step-up converter 43 to supply drive pulses to the display device 10. In particular, the microcontroller 42 causes the generation of drive pulses to switch the state of the liquid crystal layer 18 in one or more of the N areas between the focal conic and planar states. The drive pulses cause the display device 10 to display different images successively in a cycle.

The display device 10 may display only two images, in which case the microcontroller 42 causes the display device 10 to be switched alternately between display of those two images. As a result, the image seen on the display device 10 appears to flash.

Where the display device 10 displays more than two images, for example as in option (3) above, the microcontroller 42 may cause the display device 10 to switch alternately between display of two of those images, for example between the two states in any one of options (3)(a) to (3)(d) above. Alternatively, the microcontroller 42 may cause the display device 10 to switch between three or more of the images so that the image seen undergoes a more complicated change, but in a cycle. In this case, the cycle of change of the images may be regular, that is with the images repeating in the same order, or may include a degree of randomness.

The microcontroller 42 causes the switching to occur at a rate which is sufficiently high to cause the change in the image displayed on the display device 10 to attract the attention of a person. Preferably the rate is 0.1 Hz or more so that the displayed image changes every 10 seconds or less, more preferably around 1 Hz so that the image changes every second. Whilst high rates are preferred to assist in visually attracting attention, as the switching of the display device 10 consumes electrical power, the rate may be decreased to conserve the life of the battery arrangement 41.

In summary, when the display apparatus 1 is operated in this manner, the change in the image seen on the display device 10 visually attracts the attention of users to the display apparatus 1. Thus, the display apparatus 1 may be used in a wide range of applications which take advantage of this. Some examples of possible applications will now be described, but these are not limitative.

A first type of use is for the display apparatus 1 to be attached to an item and used to visually attract attention to that item. One example of this is as a label in a filing system where a plurality of display apparatuses 1 are each attached to respective, similar items stored together, for example books, files, documents or data storage media such as CDs or DVDs. In this case, the size of the display apparatus 1 is selected having regard to the size of the item labeled. In order to locate a desired item in the filing system, a signal is sent to the display apparatus 1 attached to the desired item, thereby causing the display apparatus 1 to be operated and visually to draw attention to the desired item.

A second type of use is as a sign for an item, for example an item for sale in a shop. In this case, the display apparatus 1 is attached to an item and operation of the display apparatus 1 draws attention to the item. In the context of items for sale in a shop, the display apparatus 1 might for example present a price reduction or other offer. The display apparatus 1 might draw attention to a sales promotion by indicating items newly offered for sale or by indicating an offer applicable to the item perhaps available for a limited period. In this circumstance, the display apparatus 1 has the advantage of being fixed to the items themselves, not as a separate display which might become separated from the item.

A third possible use is as a badge for an individual, for example in a gathering or to identify a visitor. In this case, operation of the display apparatus 1 can be used to identify a particular individual or can be used to indicate when the individual enters a predetermined area. Alternatively, the operation of a display apparatus 1 may be used to pass a message to the individual, thereby acting as a pager.

A fourth possible application for the display apparatus 1 is on a greetings card or invitation or the like. In this case, the display apparatus 1 may be used to draw attention to the item to which it is attached or to present some particular information in a manner which will be easily recognised.

1. A display apparatus comprising a reflective display device which comprises:
at least one bistable reflective layer which is electrically switchable between a first and a second stable states in which the bistable reflective layer consumes no power, the at least one bistable reflective layer reflecting light in the first stable state and transmitting or absorbing light in the second stable state; and
transparent electrodes shaped to apply an electric field to N areas of the at least one bistable reflective layer, where N is an integer of at most 100, for electrically switching the N areas of the at least one bistable reflective layer between the first and second stable states,
the display apparatus further comprising a control circuit electrically connected to the transparent electrodes, the control circuit being operative to generate, and to supply to the transparent electrodes, drive pulses which respectively switch the N areas between the first and second stable states to cause the reflective display device to display different images successively in a cycle.

2. A display apparatus according to claim 1, wherein the control circuit is disposed at the rear of the display device.

3. A display apparatus according to claim 2, wherein the control circuit is formed on a circuit board fixed to the rear of the display device.

4. A display apparatus according to claim 2, wherein the control circuit consists of printed circuit components.

5. A display apparatus according to claim 1, further comprising, fixed to the rear of the display apparatus, attachment means for attaching the display apparatus to another item.

6. A display apparatus according to claim 5, wherein the attachment means comprises an adhesive layer.

7. A display device according to claim 1, wherein the control circuit further comprises a sensor capable of sensing an external stimulus and the control circuit is operative in response to the sensor sensing said external stimulus.

8. A display apparatus according to claim 7, wherein the sensor is a receiver capable of receiving a signal as said external stimulus.

9. A display device according to claim 1, wherein the control circuit is operative to generate and supply to the transparent electrodes drive pulses which respectively switch the N areas between the first and second stable states to cause the reflective display device to display said different images successively at a rate of at least 0.1 Hz and in a cycle.

10. A display device according to claim 1, wherein N is at most 25.

11. A display device according to claim 1, wherein N is at most 16.

12. A display device according to claim 1, wherein N is 2.

13. A display device according to claim 1, wherein N is 1.

14. A display device according to claim 1, wherein the N areas are shaped in predetermined patterns so as to cause the reflective display device to display different images including said predetermined patterns when the N areas of the at least one bistable reflective layer are respectively switched between the first and second stable states.

15. A display apparatus according to claim 1, wherein the at least one bistable reflective layer transmits light in the second stable state, and the display device further comprises a coloured background layer behind the at least one bistable layer.

16. A display apparatus according to claim 15, wherein the coloured background layer has a predetermined pattern behind at least part of the N areas of the at least one bistable reflective layer so as to cause the reflective display device to display different images including said predetermined pattern when the N areas of the at least one bistable reflective layer are respectively switched between the first and second stable states.

17. A display apparatus according to claim 15, wherein the at least one bistable reflective layer reflects light of a predetermined colour in the first stable state.

18. A display apparatus according to claim 15, wherein the at least one bistable reflective layer is a layer of cholesteric liquid crystal material, the first stable state being a planar state of the cholesteric liquid crystal material and the second stable state being a focal conic state of the cholesteric liquid crystal material.

19. A display apparatus according to claim 1, wherein the at least one bistable reflective layer is a layer of liquid crystal material.

20. A display apparatus according to claim 1, wherein the display device comprises a single bistable reflective layer.
